(19) United States
(12) Patent Application Publication
(10) Pub. No.: US 2016/0303510 A1
(43) Pub. Date: Oct. 20, 2016

(54) Integrated Reductant Supply System

(71) Applicant: Cummins Emission Solutions Inc., Columbus, IN (US)

(72) Inventors: Zhiguo Li, Beijing (CN); Huaizhi Zhao, Beijing (CN); Junli Hu, Beijing (CN)

(73) Assignee: Cummins Emission Solutions Inc., Columbus, IN (US)

(21) Appl. No.: 14/747,749

(22) Filed: Jun. 23, 2015

(30) Foreign Application Priority Data
Apr. 15, 2015 (CN) 2015202288691

(51) Int. Cl. B01D 53/94; F01N 3/08; F01N 3/20

(52) U.S. Cl. CPC B01D 53/9431; F01N 3/2066; F01N 3/0842; B01D 53/9495; F01N 2570/14; B01D 2251/2062

(57) ABSTRACT

An integrated reductant supply system includes a reductant tank, a reductant dosing module selectively couplable to the reductant tank, an aftertreatment control module coupled to the reductant tank and in electrical communication with the reductant dosing module and a connector, and an integrated reductant supply system component. The aftertreatment control module is configured to control dosing of reductant from the reductant dosing module, and the connector configured to electrically couple to an equipment manufacturer component. The integrated reductant supply system component is coupled to the reductant tank and includes one or more of an ambient temperature sensor, a solenoid valve, a reductant level sensor, a reductant delivery line, a reductant return line, a coolant inlet line, a coolant return line, a filter, a mounting bracket, an AOS, or a wiring harness.

### CROSS-REFERENCE TO RELATED APPLICATION

The present application claims the benefit of and priority to Chinese Utility Model Application No. 2015202288691, filed Apr. 15, 2015, which is incorporated herein by reference in its entirety.

### TECHNICAL FIELD

The present application relates generally to the field of aftertreatment systems for internal combustion engines.

### BACKGROUND

For internal combustion engines, such as diesel engines, nitrogen oxide (NOₓ) compounds may be emitted in the exhaust. To reduce NOₓ emissions, a SCR process may be implemented to convert the NOₓ compounds into more neutral compounds, such as diatomic nitrogen, water, or carbon dioxide, with the aid of a catalyst and a reductant. The catalyst may be included in a catalyst chamber of an exhaust system, such as that of a vehicle or power generation unit. A reductant, such as anhydrous ammonia, aqueous ammonia, or urea is typically introduced into the exhaust gas flow prior to the catalyst chamber. To introduce the reductant into the exhaust gas flow for the SCR process, an SCR system may dose or otherwise introduce the reductant through a dosing module that vaporizes or sprays the reductant into an exhaust pipe of the exhaust system up-stream of the catalyst chamber. The SCR system may include one or more sensors to monitor conditions within the exhaust system.

### SUMMARY

Implementations described herein relate to integrated reductant supply systems. One implementation relates to an integrated reductant supply system that includes a reductant tank, a reductant dosing module selectively couplable to the reductant tank, an aftertreatment control module coupled to the reductant tank and in electrical communication with the reductant dosing module and a connector, and an integrated reductant supply system component. The aftertreatment control module is configured to control dosing of reductant from the reductant dosing module, and the connector configured to electrically couple to an equipment manufacturer component. The integrated reductant supply system component is coupled to the reductant tank and includes one or more of an ambient temperature sensor, a solenoid valve, a reductant level sensor, a reductant delivery line, a reductant return line, a coolant inlet line, a coolant return line, a filter, a mounting bracket, an AOS, or a wiring harness.

In some implementations, a portion of the reductant dosing module may be inserted into the reductant tank when the reductant dosing module is selectively coupled to the reductant tank. In other implementations, the integrated reductant supply system component is fixedly coupled to the reductant tank. In still other implementations, the reductant dosing module is selectively couplable to the reductant tank via an attachment opening formed in the reductant tank. In further implementations, the aftertreatment control module is in electrical communication with the solenoid valve and the reductant level sensor.

### BRIEF DESCRIPTION

The details of one or more implementations are set forth in the accompanying drawings and the description below. Other features, aspects, and advantages of the disclosure will become apparent from the description, the drawings, and the claims, in which:

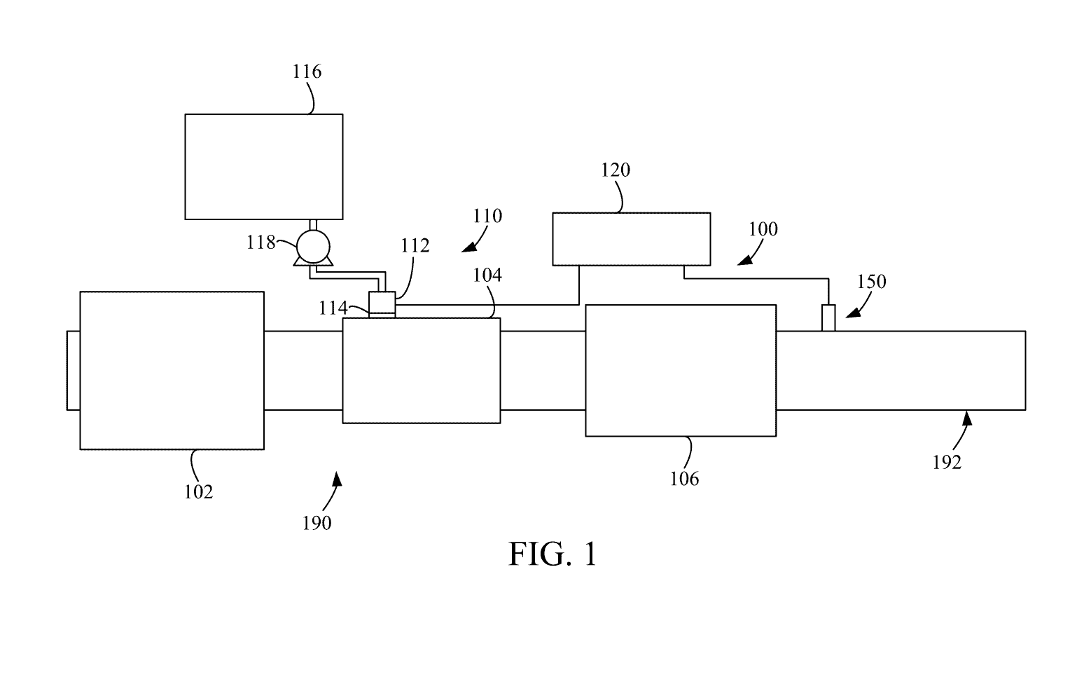

FIG. 1 is a block schematic diagram of an example selective catalytic reduction system having an example reductant delivery system for an exhaust system;

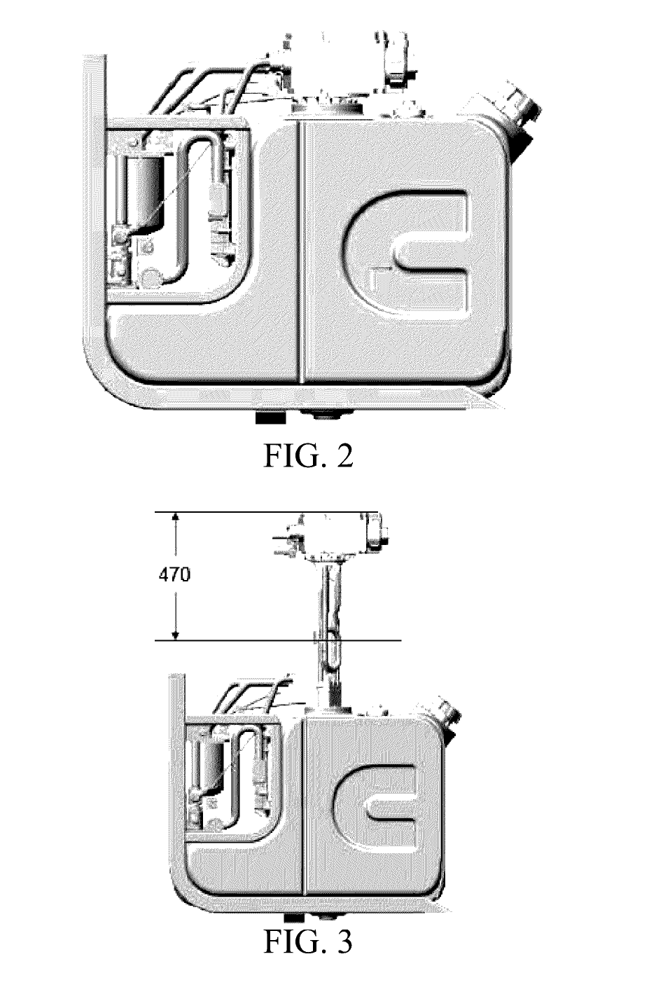

FIG. 2 is a side elevation view of an example integrated reductant supply system;

FIG. 3 is a side elevation view of the example integrated reductant supply system of FIG. 2 showing a reductant dosing module removed from a reductant tank;

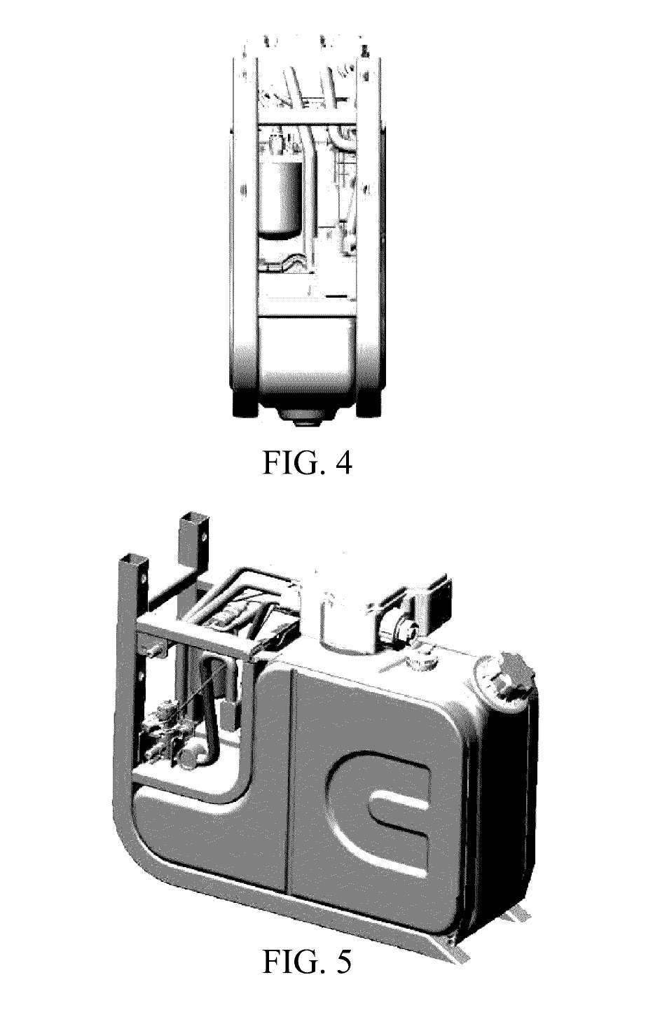

FIG. 4 is a front elevation view of the example integrated reductant supply system of FIG. 2;

FIG. 5 is a perspective view of the example integrated reductant supply system of FIG. 2;

FIG. 6 is another perspective view of the example integrated reductant supply system of FIG. 2;

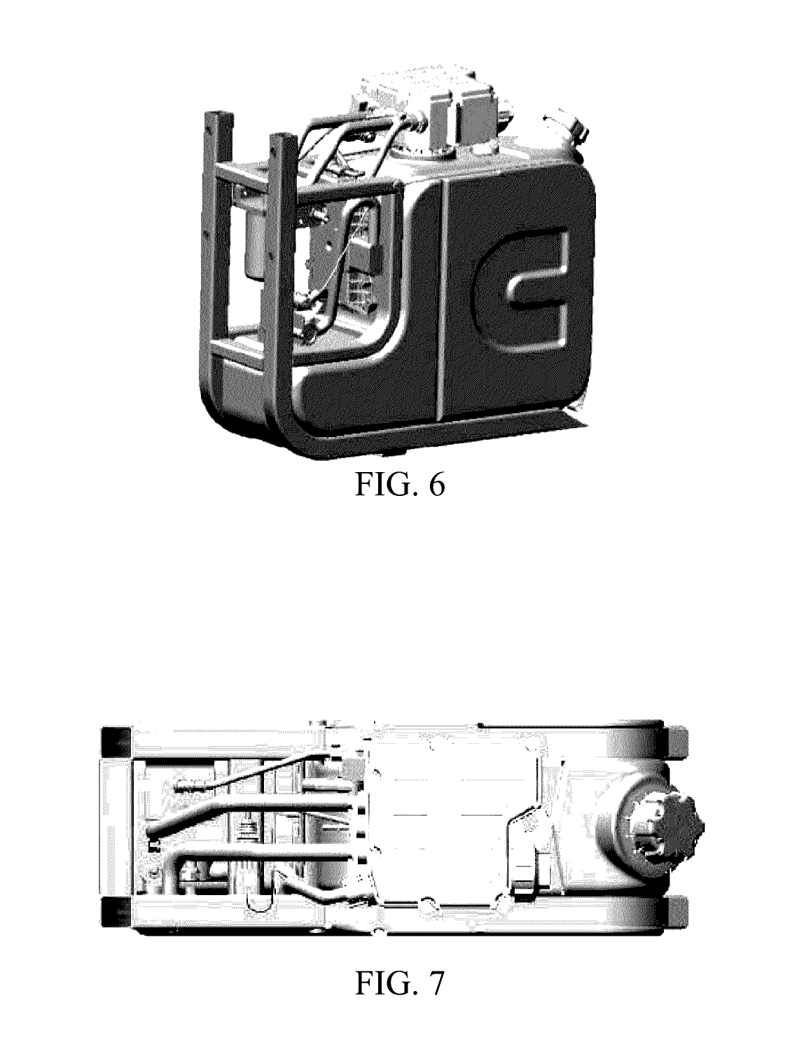

FIG. 7 is a top view of the example integrated reductant supply system of FIG. 2;

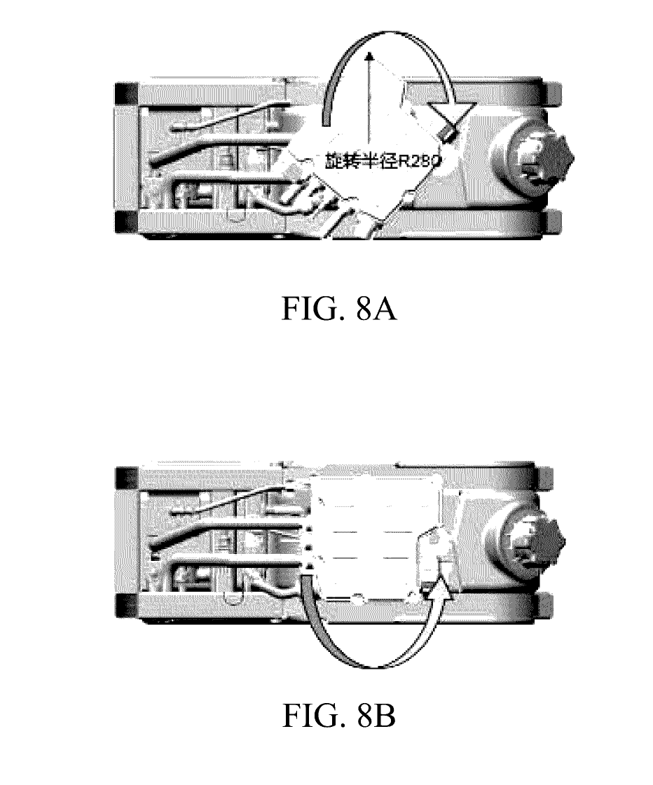

FIG. 8A is a top view of the example integrated reductant supply system of FIG. 2 showing the reductant dosing module unlocked and uncoupled from the reductant tank; and

FIG. 8B is a top view of the example integrated reductant supply system of FIG. 2 showing the reductant dosing module locked and coupled to the reductant tank.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for an integrated reductant supply system. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

In some exhaust systems, a reductant supply system includes several different components, such as a reductant tank, a reductant level sensor, a reductant dosing module, reductant delivery and/or return lines, one or more filters, one or more mounting brackets, an aftertreatment control module (ACM), an AOS, and/or a wiring harness. Such components are generally separate components to permit design modifications and/or modularity to adapt to equipment manufacturers' needs. In some implementations, an integrated reductant supply system that combines one or more of the foregoing components into an integrated system may simplify the system and/or provide equipment manufacturers with a single design such that a single connection to the integrated reductant supply system can be used by equipment manufacturers. The integrated reductant supply system can integrate the reductant level sensor, reductant dosing module, reductant delivery and/or return lines, filters, mounting brackets, ACM, AOS, and/or wiring harness into a single component that can be coupled to the reductant tank and/or into the reductant tank itself. In some implementations, the single integrated component may be configured to insert a portion thereof, such as portions of the reductant level sensor, reductant dosing module, reductant delivery and/or return lines, and/or filters, into the reductant tank through an attachment opening formed through the reductant tank and configured to couple the single component to the reductant tank. In some implementations, the single component, once aligned and inserted, can be rotated or clocked relative to the reductant tank to secure and/or seal the single component to the reductant tank. Once coupled to the reductant tank, an equipment manufacturer may only need to couple a corresponding electrical connector to the wiring harness for the reductant supply system to be integrated into the equipment of the manufacturer.

### II. Overview of Aftertreatment System

FIG. 1 depicts an aftertreatment system 100 having an example reductant delivery system 110 for an exhaust system 190. The aftertreatment system 100 includes a diesel particulate filter (DPF) 102, the reductant delivery system 110, a decomposition chamber or reactor 104, a SCR catalyst 106, and a sensor 150.

The DPF 102 is configured to remove particulate matter, such as soot, from exhaust gas flowing in the exhaust system 190. The DPF 102 includes an inlet, where the exhaust gas is received, and an outlet, where the exhaust gas exits after having particulate matter substantially filtered from the exhaust gas and/or converting the particulate matter into carbon dioxide.

The decomposition chamber 104 is configured to convert a reductant, such as urea or diesel exhaust fluid (DEF), into ammonia. The decomposition chamber 104 includes a reductant delivery system 110 having a dosing module 112 configured to dose the reductant into the decomposition chamber 104. In some implementations, the reductant is injected upstream of the SCR catalyst 106. The reductant droplets then undergo the processes of evaporation, thermolysis, and hydrolysis to form gaseous ammonia within the exhaust system 190. The decomposition chamber 104 includes an inlet in fluid communication with the DPF 102 to receive the exhaust gas containing NOₓ emissions and an outlet for the exhaust gas, NOₓ emissions, ammonia, and/or remaining reductant to flow to the SCR catalyst 106.

The decomposition chamber 104 includes the dosing module 112 mounted to the decomposition chamber 104 such that the dosing module 112 may dose the reductant into the exhaust gases flowing in the exhaust system 190. The dosing module 112 may include an insulator 114 interposed between a portion of the dosing module 112 and the portion of the decomposition chamber 104 to which the dosing module 112 is mounted. The dosing module 112 is fluidly coupled to one or more reductant sources 116. In some implementations, a pump 118 may be used to pressurize the reductant from the reductant source 116 for delivery to the dosing module 112.

The dosing module 112 and pump 118 are also electrically or communicatively coupled to a controller 120. The controller 120 is configured to control the dosing module 112 to dose reductant into the decomposition chamber 104. The controller 120 may also be configured to control the pump 118. The controller 120 may include a microprocessor, an application-specific integrated circuit (ASIC), a field-programmable gate array (FPGA), etc., or combinations thereof. The controller 120 may include memory which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller 120 can read instructions. The instructions may include code from any suitable programming language.

The SCR catalyst 106 is configured to assist in the reduction of NOₓ emissions by accelerating a NOₓ reduction process between the ammonia and the NOₓ of the exhaust gas into diatomic nitrogen, water, and/or carbon dioxide. The SCR catalyst 106 includes inlet in fluid communication with the decomposition chamber 104 from which exhaust gas and reductant is received and an outlet in fluid communication with an end of the exhaust system 190.

The exhaust system 190 may further include a diesel oxidation catalyst (DOC) in fluid communication with the exhaust system 190 (e.g., downstream of the SCR catalyst 106 or upstream of the DPF 102) to oxidize hydrocarbons and carbon monoxide in the exhaust gas.

In some implementations, the DPF 102 may be positioned downstream of the decomposition chamber or reactor pipe 104. For instance, the DPF 102 and the SCR catalyst 106 may be combined into a single unit, such as an SDPF. In some implementations, the dosing module 112 may instead be positioned downstream of a turbocharger or upstream of a turbocharger.

The sensor 150 may be coupled to the exhaust system 190 to detect a condition of the exhaust gas flowing through the exhaust system 190. In some implementations, the sensor 150 may have a portion disposed within the exhaust system 190, such as a tip of the sensor 150 may extend into a portion of the exhaust system 190. In other implementations, the sensor 150 may receive exhaust gas through another conduit, such as a sample pipe extending from the exhaust system 190. While the sensor 150 is depicted as positioned downstream of the SCR catalyst 106, it should be understood that the sensor 150 may be positioned at any other position of the exhaust system 190, including upstream of the DPF 102, within the DPF 102, between the DPF 102 and the decomposition chamber 104, within the decomposition chamber 104, between the decomposition chamber 104 and the SCR catalyst 106, within the SCR catalyst 106, or downstream of the SCR catalyst 106. In addition, two or more sensor 150 may be utilized for detecting a condition of the exhaust gas, such as two, three, four, five, or size sensor 150 with each sensor 150 located at one of the foregoing positions of the exhaust system 190

### III. Example Integrated Reductant Supply System

FIGS. 2-8B depict an example integrated reductant supply system. The integrated reductant supply system includes a reductant tank and one or more of a reductant level sensor, a reductant dosing module, reductant delivery and/or return lines, one or more filters, one or more mounting brackets, an aftertreatment control module (ACM), an AOS, and/or a wiring harness. In particular implementations, the reductant tank is a 45 liter tank. The dimensions for the integrated reductant supply system with a 45 liter tank may be 700 mm in depth by 250 mm in width by 650 mm in height. In other implementations, the reductant tank is a 60 liter tank. The dimensions for the integrated reductant supply system with a 45 liter tank may be 700 mm in depth by 400 mm in width by 650 mm in height. In some implementations, an integrated reductant supply system component includes one or more of the reductant level sensor, the reductant dosing module, reductant delivery and/or return lines, one or more filters, one or more mounting brackets, the ACM, the AOS, and/or the wiring harness. The integrated reductant supply system component can be a single component that couples to the reductant tank. In some variations, one or more of the reductant level sensor, the reductant dosing module, reductant delivery and/or return lines, one or more filters, one or more mounting brackets, the ACM, the AOS, and/or the wiring harness may be separate from the integrated reductant supply system component, such as by being mounted to the reductant tank and coupled to the integrated reductant supply system component.

Referring generally to FIGS. 2-7, the integrated reductant supply system includes the reductant tank having L-shaped brackets for mounting the integrated reductant supply system, such as to a vehicle chassis or a power generation frame, and several conduits for connecting one or more of an ambient temperature sensor, an air/oil separator inlet, a coolant return pipe, a solenoid valve, a coolant inlet port, a reductant level sensor, and/or a harness connector.

In the implementation shown, the reductant tank includes the aftertreatment control module (ACM) mounted to the reductant tank and in electrical communication with the reductant dosing module, the solenoid valve, and the reductant level sensor. The ACM includes a connector to electrically couple an equipment manufacturer control module, such as an engine control module, to the ACM. Thus, the equipment manufacturer can utilize a single connection to the integrated reductant supply system. Thus, the system integrated ACM and wiring harness makes the design of an equipment manufacturer's chassis simpler by providing the equipment manufacturer with a single connection point to couple to the integrated reductant supply system. In addition, the integrated reductant supply system can reduce assembly time and/or service time by permitting the entirety of the reductant supply system to be installed or removed.

FIGS. 8A-8B depict the integrated reductant supply system with a reductant dosing module decoupled from (FIG. 8A) and coupled to (FIG. 8B) the reductant tank and the several conduits. Thus, the reductant dosing module can be disconnected and uninstalled from or reconnected and installed to the integrated reductant supply system for assembly and/or servicing. In the implementation shown, the reductant dosing module may be coupled and/or decoupled from the reductant tank with a one-quarter rotation of the reductant dosing module. That is, a one-quarter rotation in the counter-clockwise direction relative to the reductant tank decouples the reductant dosing module from the reductant tank while a one-quarter rotation in the clockwise direction relative to the reductant tank couples the reductant dosing module to the reductant tank. A portion of the reductant dosing module may be inserted through an attachment opening formed through the reductant tank. For instance, portions of a reductant level sensor, the reductant dosing module, one or more reductant delivery and/or return lines, and/or filters, can be inserted into the reductant tank through the attachment opening. During installation, cleaning of the interface surfaces of the reductant tank and the reductant dosing module can substantially prevent contamination and/or assist in sealing the reductant dosing module to the reductant tank.

Once the reductant dosing module is coupled to the reductant tank, the several conduits and/or other connections of the integrated reductant supply system can be coupled and/or connected to the reductant dosing module. In the implementation shown, the several conduit lines may include one or more of an ambient temperature sensor, an air/oil separator inlet, a coolant return line, a solenoid valve, a coolant inlet line, a reductant level sensor, and/or a harness connector.

The term “controller” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as distributed computing and grid computing infrastructures.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

The terms “fluidly coupled,” “in fluid communication,” and the like as used herein mean the two components or objects have a pathway formed between the two components or objects in which a fluid, such as water, air, gaseous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various exemplary implementations is illustrative only and not restrictive in character. All changes and modifications that come within the spirit and/or scope of the described implementations are desired to be protected. It should be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An integrated reductant supply system comprising:
a reductant tank;
a reductant dosing module selectively couplable to the reductant tank;
an aftertreatment control module coupled to the reductant tank and in electrical communication with the reductant dosing module and a connector, the aftertreatment control module configured to control dosing of reductant from the reductant dosing module, the connector configured to electrically couple to an equipment manufacturer component; and
an integrated reductant supply system component coupled to the reductant tank, the integrated reductant supply system including one or more of:
an ambient temperature sensor,
a solenoid valve,
a reductant level sensor,
a reductant delivery line,
a reductant return line,
a coolant inlet line,
a coolant return line,
a filter,
a mounting bracket,
an AOS, or
a wiring harness.

2. The integrated reductant supply system of claim 1, wherein a portion of the reductant dosing module is inserted into the reductant tank when the reductant dosing module is selectively coupled to the reductant tank.

3. The integrated reductant supply system of claim 1, wherein the integrated reductant supply system component is fixedly coupled to the reductant tank.

4. The integrated reductant supply system of claim 1, wherein the reductant dosing module is selectively couplable to the reductant tank via an attachment opening formed in the reductant tank.

5. The integrated reductant supply system of claim 1, wherein the aftertreatment control module is in electrical communication with the solenoid valve and the reductant level sensor.
